(19) United States
(12) Patent Application Publication
(10) Pub. No.: US 2003/0197336 A1
(43) Pub. Date: Oct. 23, 2003

(54) Level control device for air suspension of a vehicle

(76) Inventor: Hyo-Sik Kim, Gyeonggi-do (KR)

Correspondence Address: Pennie & Edmonds, LLP, 3300 Hillview Avenue, Palo Alto, CA, 94304, US

(21) Appl. No.: 10/326,018

(22) Filed: Dec. 18, 2002

(30) Foreign Application Priority Data
Apr. 23, 2002 (KR) 2002-22228

(51) Int. Cl. B60G 17/01

(52) U.S. Cl. 280/5.5

(57) ABSTRACT

The present invention provides a level controlling device for an air suspension system of a vehicle. The leveling of a vehicle is automatically controlled by a bellows mounted with a cam for increasing or decreasing the distance between the body and the axle of the vehicle in response to a changing state of the air spring.

### FIELD OF THE INVENTION

The present invention relates to air springs for a vehicle. More particularly, the present invention relates to an air spring level-controlling device for a vehicle that maintains the vehicle height at a constant level.

### BACKGROUND OF THE INVENTION

Conventional level controlling devices for maintaining the height of vehicles that use air suspension systems comprise an air spring mounted between a vehicle body and an axle. A leveling valve, that supplies compressed air into or discharges the compressed air from the air spring, maintains the air pressure inside the air spring. The valve supplies or discharges compressed air depending on the relative deviation of the vehicle body and the vehicle axle.

In use, when the distance between the axle and the vehicle body is reduced the leveling valve is prompted to supply compressed air to the air spring, thereby lengthening the distance between the axle and the body and restoring the level position of the vehicle. However, when the distance between the axle and the vehicle body is extended the leveling valve is prompted to discharge compressed air from the air spring, thereby reducing the distance between the vehicle body and the axle in an attempt to level the vehicle.

There are several drawbacks with the conventional system. First, the conventional air spring suspension systems require many separate components. There is a link, leveling valve, air compressor and air tank. This increases the cost of vehicles because of the cost of these components. Furthermore, these components require a substantial amount of space. Another drawback is that the more components a system encompasses, the more likely the system is to fail or break down.

### SUMMARY OF THE INVENTION

The present invention provides a level control device for an air suspension of a vehicle, which comprises a bellows mounted in series with an air spring between a vehicle body and a vehicle axle. A cam is rotatably mounted inside the bellows to vary the length of the bellows in response to the rotation of the bellows. A pulley is rotatably mounted inside the air spring with a detecting chain is fixed to one end of the air spring and hitched at the pulley. Furthermore, there is a flexible member connected in series to one end of the detecting chain and secured at the other end to the air spring. Also, a rotation synchronizing means is included for allowing the rotating state of the cam and the pulley to be mutually transmitted.

### BRIEF DESCRIPTION OF THE DRAWINGS

For fuller understanding of the nature and objects of the invention, reference should be made to the following detailed description taken in conjunction with the accompanying drawings in which:

FIG. 1 is a schematic structural drawing illustrating an embodiment of a level control device for an air suspension of a vehicle according to an embodiment of the present invention; and

FIGS. 2 and 3 are schematic drawings illustrating a comparison of the operational states of the level control device shown in FIG. 1.

### DETAILED DESCRIPTION OF THE INVENTION

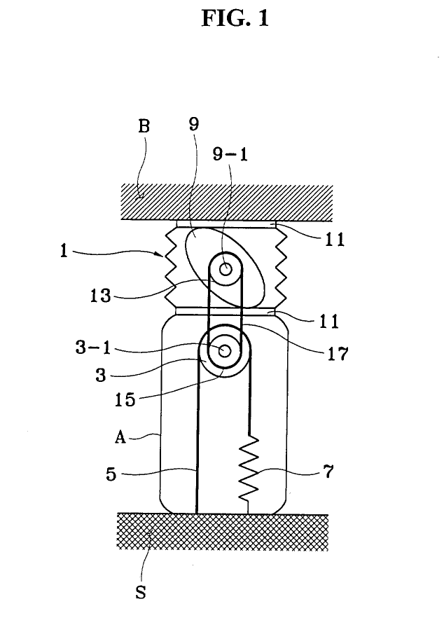

As shown in FIG. 1, an air spring (A) and a bellows 1 are mounted in series between a vehicle body (B) and a vehicle axle (S). The air spring (A) is disposed therein with a pulley 3, a detecting chain 5, and a flexible member 7. The bellows 1 is formed with a rotatably mounted cam 9 that changes the length of the bellows 1 in response to the rotating state of the cam 9. The pulley 3 is rotatably fixed within the air spring (A) via a rotating axle 3-1. The detecting chain 5 and the flexible member 7 are connected in series. The detecting chain 5 is mounted around the pulley 3 and attached to the vehicle axle (S) on one end. Similarly, the vehicle axle (S) is also attached to one end of the flexible member 7.

The bellows 1 is formed at upper and lower sides with a cam contact plate 11. Preferably the cam contact plate 11 is made of high strength durable material, and especially at a contact portion where the cam 9 contacts the cam contact plate 11. It is preferred that the cam 9 is formed in an oblong shape and the center is rotatably fixed at the middle section of the bellows 1 by a rotating axle 9-1.

There is a rotation synchronizing means, mounted between the cam 9 and the pulley 3 to allow the rotation to be transmitted therebetween. The rotation synchronizing means includes a cam pulley 13 connected to the cam 9 for integral rotation. Also included is a synchronizing pulley 15 that is rotatably connected to the pulley 3 via a concentric axle and a synchronizing chain 17 for connecting the cam pulley 13 with the synchronizing pulley 15.

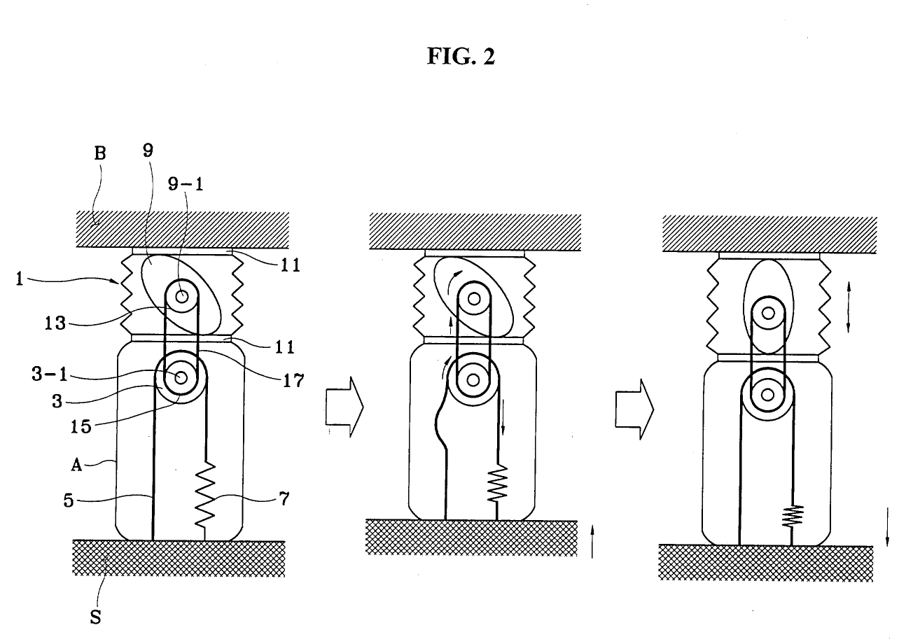

In use, when a vehicle axle maintains a standard state, not ascended nor descended relative to the vehicle body, the oval cam 9 is diagonally positioned within the bellows 1 at a long axis, as shown in the left drawing of FIG. 2. It is preferable that the cam 9 forms approximately a 45-degree angle relative to the lengthwise direction of the bellows 1. Thus, when the vehicle axle (S) is raised relative to the vehicle body (B), the air spring (A) absorbs the deviation in the distance between the vehicle body (B) and the vehicle axle (S). Therefore, the air spring (A) is shortened, as illustrated in the center drawing of FIG. 2. As a result, the distance from the rotating axle (3-1) to the vehicle axle (S) is shortened and, as such, tension on the detecting chain 5 is initially lost. The flexible member 7 then shortens, taking the slack out of the detecting chain 5 and causing the pulley to rotate in the clockwise direction. This rotates the cam 9 in a clockwise direction, which extends the distance between the vehicle axle (S) and the vehicle body (B).

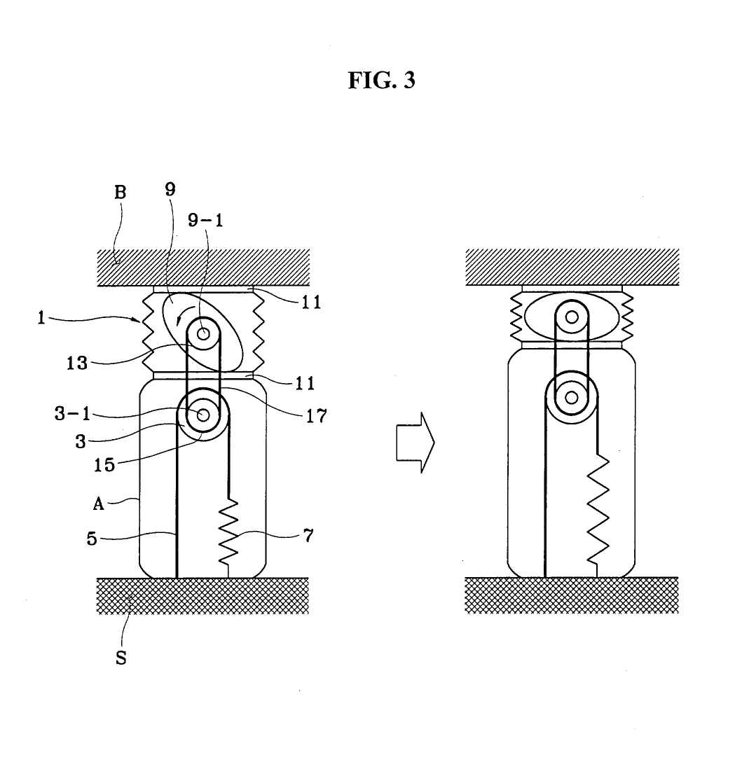

FIG. 3 shows a state where the distance between the vehicle axle (S) and the vehicle body (B) is increased. As shown in the left drawing in FIG. 3, when the distance between the vehicle body (B) and the vehicle axle (S) is expanded from the standard state, the air spring (A) is expanded. The air spring (A) lengthens between the pulley 3 and the position where the detecting chain 5 and the flexible member 7 secure to the vehicle axle (S). As a result, the flexible member 7 is elongated. This prompts the detecting chain 5 to rotate the pulley 3 counterclockwise. The counterclockwise turning effect of the pulley 3 is transmitted to the cam 9 via the synchronizing pulley 15, the synchronizing chain 17, and the cam pulley 13. The cam 9 is then rotated, as illustrated in FIG. 3, to lessen the distance between the vehicle body (B) and the vehicle axle (S), thereby enabling the vehicle to maintain a level position.

The foregoing descriptions of specific embodiments of the present invention are presented for purposes of illustration and description. They are not intended to be exhaustive or to limit the invention to the precise forms disclosed. Obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. A leveling control device for air suspension of a vehicle, comprising:
a bellows mounted in a series with an air spring between a vehicle body and a vehicle axle;
a cam mounted rotatably inside said bellows to vary the length of said bellows in response to the rotation of said cam;
a pulley rotatably mounted inside said air spring;
a detecting chain fixed to one end of said air spring and hitched at said pulley;
a flexible member connected in series at an end with one end of said detecting chain and secured at the other end to said air spring; and
a rotation synchronizing means for transferring rotation of said pulley to said cam.

2. The device of claim 1, wherein said bellows is configured at upper and lower sides with a cam contact plate.

3. The device of claim 1, wherein said cam is oval and rotatably fixed at a central lengthwise position along said bellows via a rotating axle.

4. The device of claim 1, wherein said rotation synchronizing means comprises:
a cam pulley connected to said cam for integral rotation therewith;
a synchronizing pulley rotatably connected to said pulley via a concentric axle; and
a synchronizing chain for connecting said cam pulley and said synchronizing pulley.

5. A leveling control device for air suspension of a vehicle, comprising:
an air spring;
a bellows coupled in series with said air spring; and
a position sensing mechanism configured to activate said bellows in response to a position change between a vehicle axle and a vehicle body such that said bellows returns the position between the vehicle axle and the vehicle body to a starting position.

6. The leveling control device of claim 5, wherein said position sensing mechanism comprises:
a cam rotatably mounted within said bellows;
a pulley;
a chain coupled in series with a flexible member and configured around said pulley; and
a synchronizing mechanism configured to transfer rotation of said pulley to rotation of said cam.

7. The leveling control device of claim 6, wherein said synchronizing mechanism comprises:
a cam pulley coupled with said cam;
a synchronizing pulley rotatably coupled with said pulley by a concentric axle; and
a synchronizing connecting member for connecting said cam pulley with said synchronizing pulley.
